(19) United States
(12) Patent Application Publication
(10) Pub. No.: US 2006/0274875 A1
(43) Pub. Date: Dec. 7, 2006

(54) Interface circuit for a media access controller and an optical line termination transceiver module

(76) Inventors: Jerry Darden Vereen, Coral Springs, FL (US); Thomas Jay Kitchens, Coral Springs, FL (US); Jose G. Betancourt, Miramar, FL (US)

Correspondence Address: LAW OFFICES OF MARK C. PICKERING, P.O. BOX 300, PETALUMA, CA, 94953, US

(21) Appl. No.: 11/146,532

(22) Filed: Jun. 6, 2005

(51) Int. Cl. H04L 7/00

(52) U.S. Cl. 375/371

(57) ABSTRACT

A communication system includes an interface that allows a media access controller (MAC) and an optical line termination transceiver module (TM), which have incompatible interfaces, to be connected together. The interface ensures that a clock signal and a start of frame signal have the phase relationship required by the TM, and the timing of the start of frame signal remains consistent.

### BACKGROUND OF THE INVENTION

1. Field of the Invention

The present invention relates to an interface circuit and, more particularly, to an interface circuit for a media access controller and an optical line termination transceiver module.

2. Description of the Related Art

In a conventional passive optical network (PON), one needs to be able to connect a media access controller (MAC) to an optical line termination Transceiver Module (TM). When the MAC and the TM are provided by the same manufacturer, connectivity is rarely an issue because the components are designed to operate together.

However, little interface standardization has occurred within the industry. As a result, it is often the case that a MAC that was produced by a first manufacturer can not be connected to a TM that was produced by a second manufacturer because the two components have incompatible interfaces.

For example, during normal operation, a TM receives a series of upstream cells from a MAC. (Each upstream cell can include, for example, 53×8 or 424 bits, based on 53 octets per cell.) Each time an upstream cell is received, the TM reacquires the needed cell timing. To reacquire the cell timing, a TM typically requires that one start of frame pulse accompany each upstream cell, and occur at a specific time with respect to each upstream cell.

In addition, the TM typically defines the characteristics of the start of frame pulse, including the width and active state polarity of the start of frame pulse. Further, the TM has set up and hold time requirements which must be met. In addition, the TM can require that a clock signal occur at a specific phase of the start of frame pulse.

Thus, there is a need for an approach that insures that the TM receives the start of frame pulse as required when the MAC does not provide the needed interface.

### SUMMARY OF THE INVENTION

An interface circuit is disclosed. The interface circuit includes a sampling circuit to generate and output a sampled clock signal in response to a first clock signal and a second clock signal. The sampling circuit also generates and outputs a plurality of intermediate frame pulses in response to a plurality of reset pulse and the second clock signal. Each intermediate frame pulse has a width which has an integer number of phases defined by a corresponding number of second clock periods. The reset pulses and the second clock signal have an unknown phase relationship. The sampling circuit also generates and outputs a plurality of start of frame pulses in response to the intermediate frame pulses and the first clock signal.

A method of operating an interface circuit is disclosed according to an embodiment of the present invention. A plurality of timing signals is generated. The timing signals include a sampled clock signa, a plurality of intermediate frame pulses, and a plurality of start of frame pulses. When a measurement period begins, a series of phase values are detected and output. Each phase value represents a phase of an intermediate frame pulse that corresponds with an active edge of the sampled clock signal.

A method of determining a value for a burst CDR generation register is disclosed according to an embodiment of the present invention. A first value is read. The first value identifies a phase relationship of a first signal to a second signal. In addition, the first value is looked up in a look up table to determine a register value when the first value is valid. In addition, the register value is written into the burst CDR generation register. The register value held by the burst CDR generation register defines a timing of the first signal.

A better understanding of the features and advantages of the present invention will be obtained by reference to the following detailed description and accompanying drawings that set forth an illustrative embodiment in which the principles of the invention are utilized.

### BRIEF DESCRIPTION OF THE DRAWINGS

FIG. 1 is a block diagram illustrating an example of a communication system 100 in accordance with the present invention.

FIG. 2 is a block diagram illustrating an example of an embodiment 200 of communication system 100 in accordance with the present invention.

FIG. 3 is a flow chart illustrating an example of a method 300 of operating an interface circuit in accordance with the present invention.

FIG. 4 is a block diagram illustrating an example of an embodiment 400 of communication system 100 in accordance with the present invention.

FIGS. 5A-5P are timing diagrams illustrating an example of the operation of a sampling logic circuit, such as sampling logic circuit 210, and a phase position detection circuit, such as phase position detection circuit 212, in accordance with the present invention.

FIG. 6 is a flow chart illustrating an example of a method 600 of determining a value for a burst CDR generation register, such as burst CDR generation register 112A, in accordance with the present invention.

### DETAILED DESCRIPTION OF THE INVENTION

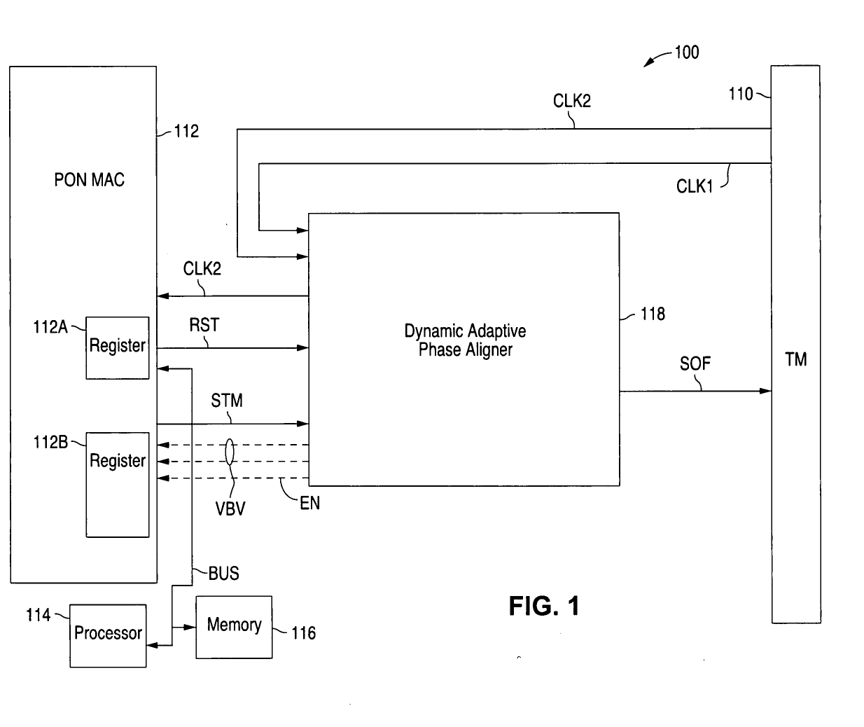

FIG. 1 shows a block diagram that illustrates an example of a communication system 100 in accordance with the present invention. As described in greater detail below, communication system 100 includes an interface that allows a media access controller and an optical line termination transceiver module, which have incompatible interfaces, to be connected together.

As shown in FIG. 1, communication system 100 includes an optical line termination transceiver module (TM) 110 that outputs a first clock signal CLK1 and a second clock signal CLK2, which is a multiple of the first clock signal CLK1. For example, the first clock signal CLK1 can have a frequency of 39 MHz (38.88 MHz), while the second clock signal CLK2 can have a frequency of 156 MHz (155.52 MHz), which is 4× greater. Further, the first and second clock signals CLK1 and CLK2 can be frequency locked to each other.

In addition to outputting the first and second clock signals CLK1 and CLK2, TM 110 also receives a series of upstream cells, and a corresponding series of start of frame pulses SOF such that a start of frame pulse SOF accompanies each upstream cell. In the present example, TM 110 requires that a start of frame pulse SOF occur at a specific time with respect to each upstream cell.

Further, TM 110 defines a width of the start of frame pulse SOF, as well as an active state polarity. In the present example, the start of frame pulse SOF can be four bit times long (four second-clock periods long or one first-clock period). Thus, four rising edges of the second clock signal CLK2 or four phases occur during the start of frame pulse SOF. In addition, the start of frame pulse SOF can be active high.

Further, to insure that the set up and hold times of TM 110 are met, the rising edges of the first clock signal CLK1 should occur as close as possible to one of the four phase positions of the four-bit wide SOF pulses. (One of the four phase positions provides the best margin in terms of satisfying the set up and hold times of TM 110.) In the present example, to insure that the set up and hold times are met, the rising edges of the first clock signal CLK1 occur as close as possible to the centers of the SOF pulses, i.e., on the third phase or third rising edge of the four second-clock periods that define each SOF pulse.

Communication system 100 also includes a passive optical network (PON) media access controller (MAC) 112 that receives the second clock signal CLK2, and outputs a series of burst CDR reset pulses RST. In the present example, MAC 112 does not utilize or receive the first clock signal CLK1. Further, the burst CDR reset pulses RST output by MAC 112 have an unknown phase relationship with respect to the second clock signal CLK2.

In addition, MAC 112 includes a burst CDR generation register 112A that defines the burst CDR reset pulse RST. The burst CDR generation register holds an N-bit value that defines a position before a defined point in each upstream cell, a K-bit value that defines a width of the burst CDR reset pulse RST, and a G-bit value that defines the active state polarity.

In the present example, the width of the burst CDR reset pulse RST is set to match the width required by the start of frame pulse SOF, i.e., four bit times (four second-clock CLK2 periods). Thus, four rising edges of the second clock signal CLK2 or four phases occur during the burst CDR reset pulse RST. Further, the active state polarity is set to match the polarity required by the start of frame SOF pulse, e.g., active high. In addition, the position of the rising edge of the burst CDR reset pulse RST can be advanced or retarded in time with one-bit granularity by changing the N-bit value held by burst CDR generation register 112A.

Communication system 100 further includes a processor 114, a memory 116, and a communication path BUS that is connected to MAC 112, processor 114, and memory 116. In the present example, processor 114 is connected to burst CDR generation register 112A of MAC 112 to write a value into the N-bit, K-bit, and G-bit fields of register 112A, which is addressable via communication path BUS.

Processor 114, which can be implemented with, for example, a 32-bit processor, operates on data in response to program instructions. Memory 116 stores an operating system and a set of program instructions. The operating system can be implemented with, for example, the VxWorks operating system, although other operating systems can alternately be used. The program instructions can be written in, for example, C although other languages can alternately be used.

In addition, as described in greater detail below, memory 116 also stores data, which includes a look up table that lists a number of phase conditions, and a corresponding number of register values. (Communications system 100 also includes circuitry for inserting information into memory 116, and removing information from memory 116.)

In accordance with the present invention, communication system 100 includes a dynamic adaptive phase aligner (DAPA) circuit 118 that generates and outputs the start of frame pulses SOF in response to the first and second clock signals CLK1 and CLK2 from TM 110, and the burst CDR reset pulses RST from MAC 112. In addition, DAPA circuit 118 passes the second clock signal CLK2 onto MAC 112. (MAC 112 can alternately receive the second clock signal CLK2 directly from TM 110.)

DAPA circuit 118 ensures that the rising edges of the first clock signal CLK1 occur as close as possible to a predetermined phase of each start of frame pulse SOF, such as the third phase. In addition, DAPA circuit 118 ensures that the timing of the start of frame pulses SOF remains consistent by ensuring that a predefined phase relationship exists between the burst CDR reset pulses RST and the rising edges of the first clock signal CLK1.

Further, DAPA circuit 118 outputs a validated phase value VBV and an enable signal EN. The validated phase value VBV identifies the phase relationships that exist between the burst CDR reset pulses RST and the rising edges of the first clock signal CLK1, while the enable signal EN indicates that the validated phase value VBV is valid.

Processor 114 reads the validated phase value VBV from DAPA circuit 118 via communication path BUS (as shown by the dashed lines connected to DAPA circuit 118). Processor 114 evaluates the validated phase value VBV and, when needed to ensure that the timing of the start of frame pulses SOF remains consistent, writes a register value from memory 116 into burst CDR generation register 112A based on the validated phase value VBV.

The new register value changes the timing of the burst CDR reset pulse RST by one second-clock period. This changes the phase relationship between the burst CDR reset pulses RST and the rising edges of the first clock signal CLK1 which, in turn, can change the timing of the start of frame pulses SOF. Thus, the present invention varies the timing of the burst CDR reset pulses RST to vary a phase relationship between the burst CDR reset pulses RST and the first clock signal CLK1 to ensure the proper timing of the start of frame pulses SOF.

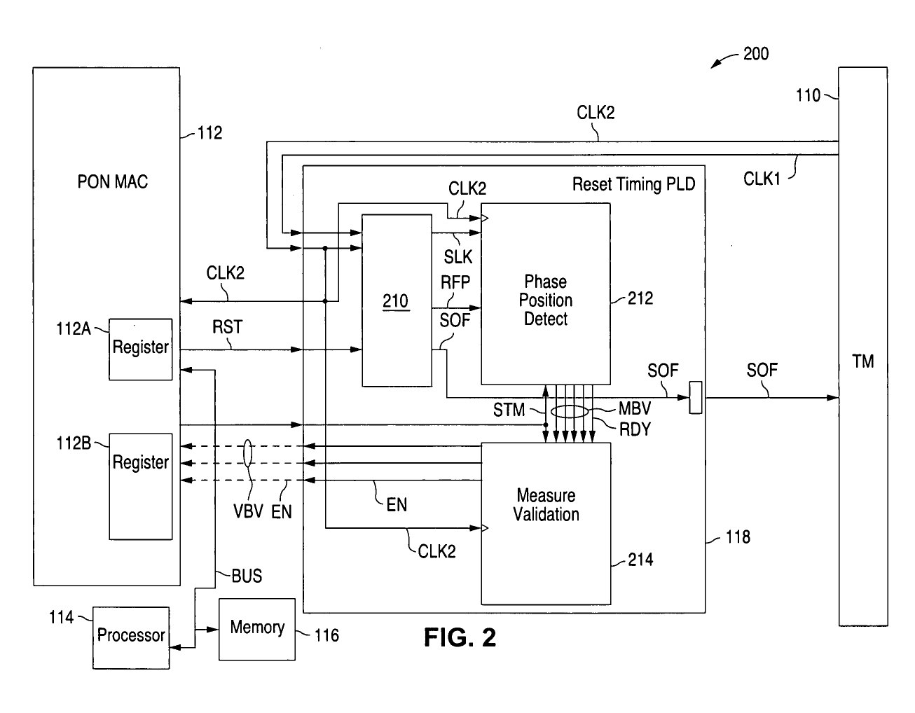

FIG. 2 shows a block diagram that illustrates an example of an embodiment 200 of communication system 100 in accordance with the present invention. As shown in FIG. 2, DAPA circuit 118 of embodiment 200 includes a sampling circuit 210 that generates and outputs a number of timing signals. The timing signals include a sampled clock signal SLK, a series of regenerated frame pulses RFP, and the start of frame pulses SOF. In addition, the timing signals are formed in response to the first clock signal CLK1, the second clock signal CLK2, and the burst CDR reset pulses RST.

Further, DAPA circuit 118 ensures that the timing of the start of frame pulses SOF remains consistent by ensuring that the regenerated frame pulses RFP are properly timed with respect to the sampled clock signal SLK which, in turn, can be a synchronized version of the first clock signal CLK1.

To properly time the regenerated frame pulses RFP, DAPA circuit 118 includes a phase position detect circuit 212 that is connected to sampling circuit 210. Over a measurement period, phase position detect circuit 212 determines a series of phase values that represent the phase relationships between the regenerated frame pulses RFP and the sampled clock signal SLK.

In other words, for each regenerated frame pulse RFP that occurs during the measurement period, phase position detect circuit 212 determines which phase of the regenerated frame pulse RFP coincides with the rising edge of the sampled clock signal SLK. In addition, phase position detect circuit 212 reports the series of phase values that are detected during the measurement period as a series of measured phase values MBV.

Thus, over a measurement period, phase position detect circuit 212 detects a series of phase relationships, and outputs a series of measured phase values MBV that indicate the phase relationships that were detected. In addition, phase position detect circuit 212 also outputs a ready signal RDY which indicates that the measured phase value MBV is ready.

DAPA circuit 118 of embodiment 200 additionally includes a measure validation circuit 214 that is connected to phase position detect circuit 212. Measure validation circuit 214 receives the series of measured phase values MBV output from phase position detect circuit 212, and records which phase values were present during the measurement period. At the end of the measurement period, measure validation circuit 214 generates and outputs a validated phase value VBV that indicates the phase values that were detected.

For example, if the measured phase values MBV received from phase position detect circuit 212 during a measurement period include X phase 2 values and Y phase 3 values, measure validation circuit 214 records that phase 2 and phase 3 values were received. At the end of the measurement period, measure validation circuit 214 generates and outputs a validated phase value VBV that indicates that phase 2 and phase 3 values were received, and an enable signal EN that indicates that the validated phase value VBV is valid.

To identify a measurement period, phase position detect circuit 212 and measured validation circuit 214 both receive a start signal STM. The start signal STM moves to a first logic state when a measurement period begins, and to a second logic state when the measurement period ends.

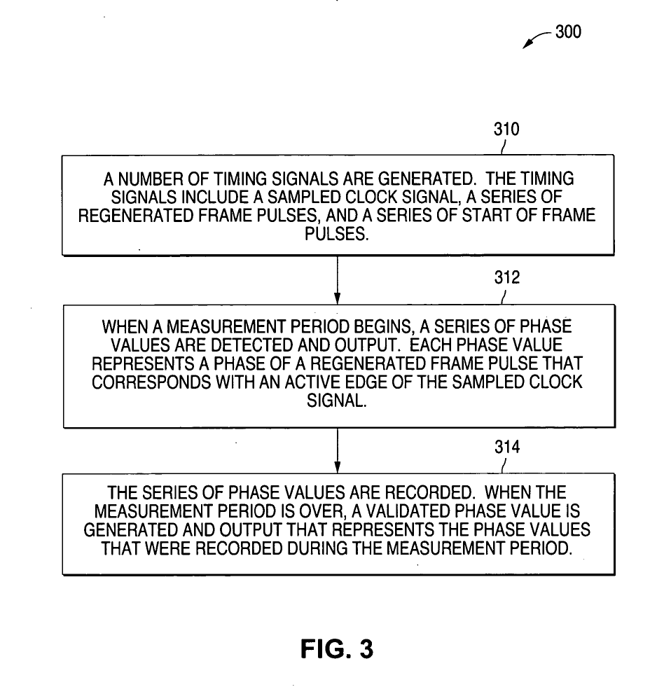

FIG. 3 shows a flow chart that illustrates an example of a method 300 of operating an interface circuit in accordance with the present invention. As shown in FIG. 3, at 310, a number of timing signals are generated. The timing signals include a sampled clock signal, a series of regenerated frame pulses, and a series of start of frame pulses. In addition, the timing signals are formed in response to a first clock signal, a second clock signal, and a series of burst CDR reset pulses.

The rising edge of the first clock signal can be aligned with a rising edge of the second clock signal to form the sampled clock signal. For example, sampling circuit 210 can align the rising edge of the first clock signal CLK1 to a rising edge of the second clock signal CLK2 to form the sampled clock signal SLK.

In addition, the regenerated frame pulses can be formed in response to the burst CDR reset pulses and the second clock signal. For example, sampling circuit 210 can align a rising edge of a burst CDR reset pulse RST with a rising edge of a second clock signal CLK2, and then reconstruct the pulse to form a regenerated frame pulse. The regenerated frame pulse has a width defined by a plurality of phases that correspond to a plurality of periods of the second clock signal.

For example, sampling circuit 210 can form a regenerated frame pulse RFP in response to an edge of the second clock signal CLK2 and an edge of the burst CDR reset pulse RST. The formation of the regenerated frame pulse ensures that a pulse with the proper width is generated.

Further, since both the sampled clock signal and the regenerated frame pulse are aligned to the second clock signal, an active edge of the sampled clock signal is aligned and corresponds with a phase of the regenerated frame pulse. In other words, the rising edge of the sampled clock signal SLK can occur during the regenerated frame pulse RFP, and coincide with the rising edge of one of second clock periods.

A start of frame pulse can also be formed in response to the regenerated frame pulse and the first clock signal. For example, sampling circuit 210 can additionally form a start of frame pulse SOF in response to the regenerated frame pulse RFP and the first clock signal CLK1. As noted above, the burst CDR reset pulse RST, the regenerated frame pulse RFP, and the start of frame pulse SOF each have equal widths that are equal to a number of second clock periods, e.g., four.

At 312, when a measurement period begins, a series of phase values are detected. Each phase value represents a phase of a regenerated frame pulse that corresponds with an active edge of the sampled clock signal. For example, phase position detect circuit 212 determines which phase or second-clock rising edge of the regenerated frame pulse RFP coincides with the rising edge of the sampled clock signal SLK.

In addition, a series of measured phase values can be generated in response to the series of detected phase values. Each measured phase value can have an n-bit value that identifies a detected phase value. For example, phase position detect circuit 212 can output a four-bit measured phase value MBV of 1-0-0-0 when phase 0 is detected, 0-1-0-0 when phase 1 is detected, 0-0-1-0 when phase 2 is detected, and 0-0-0-1 when phase 3 is detected.

At 314, the series of measured phase values are recorded. When the measurement period is over, a validated phase value is generated and output that represents the phase values that were recorded during the measurement period. For example, measure validation circuit 214 can record the phase values that were detected during the measurement period, and generate and output a validated phase value VBV that identifies the phase values that were detected during the measurement period.

Processor 114 reads the validated phase value VBV from measure validation circuit 214 via communication path BUS (as shown by the dashed lines connected to register 112B). Based on the validated phase value VBV, processor 114 writes a register value from memory 116 into burst CDR generation register 112A when needed.

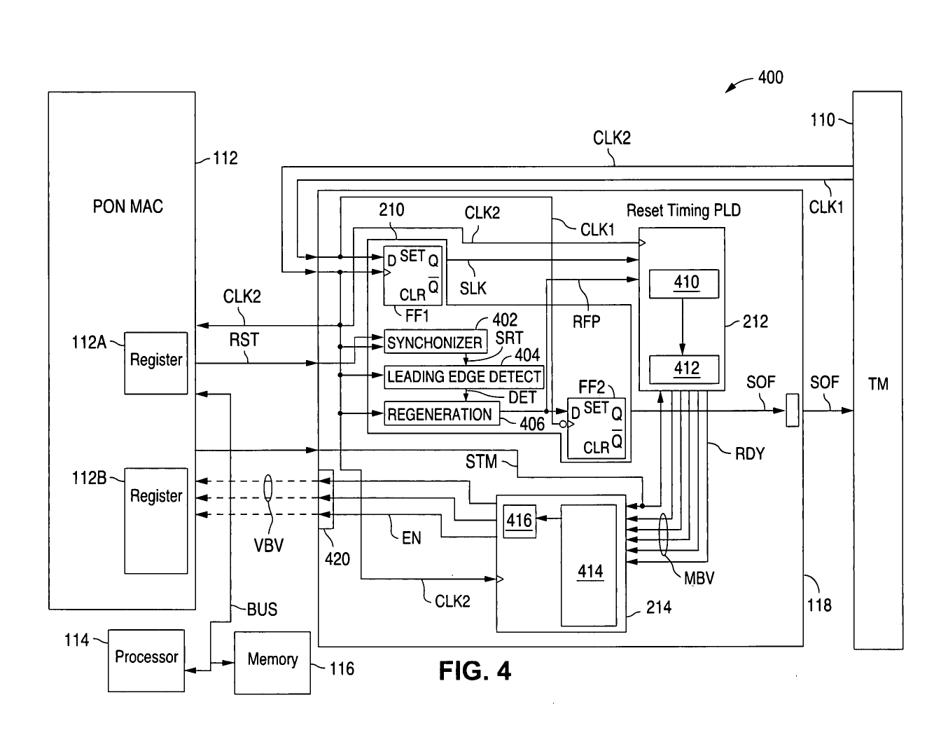

FIG. 4 shows a block diagram that illustrates an example of an embodiment 400 of communication system 100 in accordance with the present invention. In the FIG. 4 embodiment, sampling circuit 210 generates and outputs a sampled clock signal SLK by aligning the first clock signal CLK1 to the second clock signal CLK2. As a result, the sampled clock signal SLK is a synchronized version of the first clock signal CLK1 that is aligned to the second clock signal CLK2.

For example, as shown in FIG. 4, sampling circuit 210 can include a flip flop FF1 that has a D input that receives the first clock signal CLK1, and a clock input that receives the second clock signal CLK2. Flip flop FF1 also has a Q output that generates the sampled clock signal SLK, which has a logic high when the first clock signal CLK1 is high on the rising edge of the second clock signal CLK2, and a logic low when the first clock signal is low on the rising edge of the second clock signal.

In addition, sampling circuit 210 generates and outputs the regenerated frame pulses RFP by aligning the burst CDR reset pulses RST to the second clock signal CLK2, and ensuring that pulses with the proper width are generated. As a result, the regenerated frame pulses RFP are a synchronized version of the burst CDR reset pulses RST that is aligned to the second clock signal CLK2. Thus, the sampled clock signal SLK and the regenerated frame pulse RFP are both aligned to the second clock signal CLK2.

For example, as further shown in FIG. 4, sampling circuit 210 can also include a synchronizer 402 that synchronizes the burst CDR reset pulses RST to the second clock signal CLK2 to output a series of synchronized reset pulses SRT. For example, synchronizer 402, which can be implemented with a two-stage flip flop, can output the synchronized reset pulses SRT with logic highs when the burst CDR reset pulses RST are high on the rising edge of the second clock signal CLK2, and logic lows when the burst CDR reset pulses RST are low on the rising edge of the second clock signal CLK2.

In addition, sampling circuit 210 can include a leading edge detect circuit 404 that outputs an edge signal DET when the leading edge of a synchronized reset pulse SRT is detected. Further, sampling circuit 210 can include a regeneration circuit 406 that outputs a regenerated frame pulse RFP in response to the detected signal DET.

Regeneration circuit 406 ensures that a pulse with the proper width is generated. The proper width of the regenerated frame pulse RFP is equal to the same number of second clock phases or periods as the burst CDR reset pulse RST. Thus, sampling circuit 210 generates and outputs a regenerated frame pulse RFP in response to the burst CDR reset pulse RST and the second clock signal CLK2.

Further, sampling circuit 210 generates and outputs the start of frame pulses SOF in response to the regenerated frame pulses RFP and the first clock signal CLK1. The burst CDR reset pulses RST, the regenerated frame pulses RFP, and the start of frame pulses SOF each have equivalent widths.

For example, sampling circuit 210 can include a flip flop FF2 that has a D input that receives the regenerated frame pulse RFP, and an inverted clock input that receives the first clock signal CLK1. Flip flop FF2 also has a Q output that generates the start of frame pulse SOF, which has a logic high on the falling edge of the first clock signal CLK1, when the regenerated frame pulse RFP has a logic high.

Thus, the regenerated frame pulse RFP is clocked by the falling edge of the first clock signal CLK1 to output the start of frame pulse SOF. The clocking provided by flip flop FF2 ensures that the rising edge of the first clock signal CLK1 occurs as close as possible to the center of the start of frame pulse SOF.

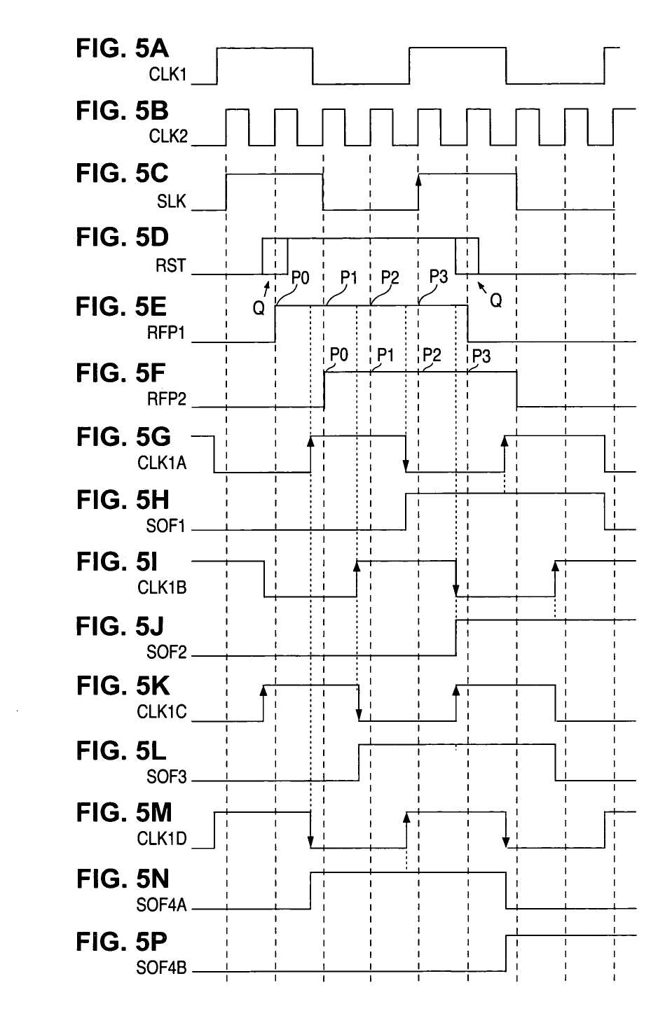

FIGS. 5A-5P show timing diagrams that illustrate an example of the operation of a sampling logic circuit, such as sampling logic circuit 210, and a phase position detection circuit, such as phase position detection circuit 212, in accordance with the present invention. As shown in FIGS. 5A-5C, the rising edge of the first clock signal CLK1 is synchronized to the rising edge of the second clock signal CLK2. As a result, the sampled clock signal SLK is generated with a period which is substantially identical to the period of the first clock signal CLK1, and a rising edge that coincides with a rising edge of the second clock signal CLK2.

In addition, as shown in FIG. 5D, the burst CDR reset pulse RST can occur at any time with respect to the second clock signal CLK2, including during an uncertainty period Q. The uncertainty period Q includes a time before the rising edge of the second clock signal CLK2 that just satisfies the set up and hold time of synchronizer 402, and a time that just misses the set up and hold time of synchronizer 402.

As shown in FIG. 5E, when the rising edge of the burst CDR reset pulse RST just satisfies the set up and hold time of synchronizer 402, a regenerated frame pulse RFP1 is generated in response to the burst CDR reset pulse RST. On the other hand, as shown in FIG. 5F, when the rising edge of the burst CDR reset pulse RST just misses the set up and hold time of synchronizer 402, a regenerated frame pulse RFP2 is generated in response to the burst CDR reset pulse RST.

Thus, when the rising edge of the burst CDR reset pulse RST occurs during the uncertainty period Q, the resulting regenerated frame pulse RFP can be either RFP1 or RFP2, depending on whether the rising edge of the burst CDR reset pulse RST satisfies or misses the set up and hold times of synchronizer 402.

As further shown in FIGS. 5E and 5F, four phases P0-P3 or four rising edges of the second clock signal CLK2 occur during a regenerated frame pulse RFP1, and four phases P0-P3 or four rising edges of the second clock signal CLK2 occur during a regenerated frame pulse RFP2. A first phase P0 of a regenerated frame pulse RFP coincides with the rising edge of the first of the four rising edges of the second clock signal CLK2 that occur during the regenerated frame pulse RFP. A second phase P1 of the regenerated frame pulse RFP coincides with the rising edge of the second of the four rising edges of the second clock signal CLK2 that occur during the regenerated frame pulse RFP.

A third phase P2 of the regenerated frame pulse RFP coincides with the rising edge of the third of the four rising edges of the second clock signal CLK2 that occur during the regenerated frame pulse RFP. A fourth phase P3 of the regenerated frame pulse RFP coincides with the rising edge of the fourth of the four rising edges of the second clock signal CLK2 that occur during the regenerated frame pulse RFP.

When a regenerated frame pulse RFP is output, the regenerated frame pulse RFP can have one of four possible phase relationships with respect to the first clock signal CLK1. FIG. 5G shows a first example where a first clock signal CLK1A rises just before the regenerated frame pulse RFP2 rises. As shown in the first example, when the first clock signal CLK1A falls, both the regenerated frame pulse RFP1 and the regenerated frame pulse RFP2 have a logic high.

As a result, regardless of whether the regenerated frame pulse RFP1 or the regenerated frame pulse RFP2 was generated, the result is the same. Thus, as shown in FIG. 5H, the rising edge of the start of frame pulse SOF1 is generated in response to the falling edge of the first clock signal CLK1. This, in turn, guarantees that the rising edge of the first clock signal CLK1A will occur as close as possible to the center or the third phase of the start of frame pulse SOF1.

FIG. 5I shows a second example where a first clock signal CLK1B falls one second clock period later than in the first example. As with the first example, when the first clock signal CLK1B falls, both the regenerated frame pulse RFP1 and the regenerated frame pulse RFP2 have a logic high.

As a result, regardless of whether the regenerated frame pulse RFP1 or the regenerated frame pulse RFP2 was generated, the result is the same. Thus, as shown in FIG. 5I, the rising edge of the start of frame pulse SOF2 is generated in response to the falling edge of the first clock signal CLK1B. This, in turn, guarantees that the rising edge of the first clock signal CLK1B will occur as close as possible to the center or the third phase of the start of frame pulse SOF2.

FIG. 5K shows a third example where a first clock signal CLK1C falls one second clock period earlier than in the first example. As with the first example, when the first clock signal CLK1C falls, both the regenerated frame pulse RFP1 and the regenerated frame pulse RFP2 have a logic high.

As a result, regardless of whether the regenerated frame pulse RFP1 or the regenerated frame pulse RFP2 was generated, the result is the same. Thus, as shown in FIG. 5L, the rising edge of the start of frame pulse SOF3 is generated in response to the falling edge of the first clock signal CLK1C. This, in turn, guarantees that the rising edge of the first clock signal CLK1C will occur as close as possible to the center or the third phase of the start of frame pulse SOF3.

FIG. 5M shows a fourth example where the first clock signal CLK1D falls two second clock periods earlier than in the first example. However, in this example, unlike the first example, when the first clock signal CLK1D falls, the regenerated frame pulse RFP1 has a logic high, while the regenerated frame pulse RFP2 has a logic low.

As a result, as shown in FIG. 5N, the rising edge of a start of frame pulse SOF4A is generated in response to the falling edge of the first clock signal CLK1D when pulse RFP1 is generated. On the other hand, as shown in FIG. 5P, the rising edge of a start of frame pulse SOF4B is generated in response to the falling edge of the first clock signal CLK1D when pulse RFP2 is generated.

As shown in FIGS. 5N and 5P, the start of frame pulse SOF4B trails the start of frame pulse SOF4A by one first clock period. Thus, the uncertainty period Q causes one of two different start of frame pulses SOF4A or SOF4B to be generated, depending on whether the rising edge of the burst CDR reset pulse RST satisfies or misses the set up and hold times of synchronizer 402.

In addition, if the rising edges of the burst CDR reset pulses RST are so close to the threshold set up and hold times of synchronizer 402 that the output switches back and forth between pulse RFP1 and pulse RFP2, the start of frame pulses also unacceptably jump back and forth between pulses SOF4A and SOF4B, yielding a start of frame pulse SOF with inconsistent timing.

Referring again to the FIG. 4 embodiment, phase position detect circuit 212 can include a logic measuring circuit 410, and an output circuit 412. Logic measuring circuit 410 can determine which phase P0-P3 of the regenerated frame pulse RFP coincides with the rising edge of the sampled clock signal SLK (a synchronized version of the first clock signal CLK1) by detecting the logic state of the sampled clock signal SLK that occurs with and after the detection of a 4-bit wide high on the regenerated frame pulse RFP. Output circuit 412 can report the phase of the regenerated frame pulse RFP that coincides with the rising edge of the sampled clock signal SLK as a measured phase value MBV.

Logic measuring circuit 410 samples the sampled clock signal SLK on the rising edge of the regenerated frame pulse RFP to determine a first logic state. In addition, logic measuring circuit 410 samples the sampled clock signal SLK one second-clock period after the rising edge of the regenerated frame pulse RFP to determine a second logic state. (For robustness, six samples of the regenerated frame pulse RFP can be taken, which consist of the four logic 1's of the RFP pulse, which is preceded by a logic 0 and succeeded by a logic 0.) For example, as illustrated in FIG. 5E with the regenerated frame pulse RFP1, when the rising edge of a regenerated frame pulse RFP occurs during the center of the logic high of the sampled clock signal SLK, the logic state of the sampled clock signal SLK is high. One second-clock period later, the logic state of the sampled clock signal SLK remains high.

This high-high combination is a unique sequence that indicates that the rising edge of the sampled clock signal SLK coincides with phase P3 or the fourth rising edge of the four second-clock signals CLK2 that define the regenerated frame pulse RFP. Output circuit 412 can report that phase P3 is aligned with the rising edge of the sampled clock signal SLK by outputting a measured phase value MBV.

In addition, as illustrated in FIG. 5F with the regenerated frame pulse RFP2, when the rising edge of a regenerated frame pulse RFP is coincident with the falling edge of the sampled clock signal SLK, the logic state of the sampled clock signal SLK is detected as a high. However, one second-clock period later, the logic state of the sampled clock signal SLK is low.

This high-low combination is a unique sequence that indicates that the rising edge of the sampled clock signal SLK coincides with phase P2 or the third rising edge of the four second-clock signals CLK2 that define the regenerated frame pulse RFP. Output circuit 412 can report that the rising edge of the sampled clock signal SLK is aligned with phase P2 by outputting a measured phase value MBV.

Similarly, when the rising edge of the regenerated frame pulse RFP is coincident with the middle of the low period of the sampled clock pulse, the logic state of the sampled clock signal SLK is low. In addition, one second-clock period later, the logic state of the sampled clock signal SLK remains the same.

This low-low combination is also unique sequence that indicates that the rising edge of the sampled clock signal SLK coincides with phase P1 or the second rising edge of the four rising edges of the second clock signals CLK2 that define the start of frame pulse SOF. Thus, when the logic state of the regenerated frame pulse RFP is high and the logic state of the sampled clock signal SLK is low two second-clock periods in a row, output circuit 412 reports that the rising edge of the sampled clock signal SLK coincides with phase P1.

In addition, when the rising edge of the regenerated frame pulse RFP is coincident with the rising edge of the sampled clock signal SLK, the logic state of the sampled clock signal SLK is low. One second-clock period later, however, the logic state of the sampled clock signal SLK is high.

This low-high combination is a unique sequence that indicates that the rising edge of the sampled clock signal SLK coincides with phase P0 or the first rising edge of the four second-clock signals CLK2 that define the regenerated frame pulse RFP. Output circuit 412 can report that the rising edge of the sampled clock signal SLK is aligned with phase P0 by outputting a measured phase value MBV.

In addition to outputting the measured phase values MBV, output circuit 412 of phase position detect circuit 212 can also output a ready signal RDY that indicates whether the measured phase value MBV is ready to be read.

Thus, over a measurement period, a series of measured phase values MBV are generated by output circuit 412 in response to the series of detected phase values P0-P3. Each measured phase value MBV can have an n-bit value that identifies a detected phase value. For example, phase position detect circuit 212 can output a four-bit measured phase value MBV of 1-0-0-0 when phase 0 is detected, 0-1-0-0 when phase 1 is detected, 0-0-1-0 when phase 2 is detected, and 0-0-0-1 when phase 3 is detected.

Referring again to the FIG. 4 embodiment, measure validation circuit 214 can include a flop circuit 414 that records the measured phase values MBV received from phase position detect circuit 212 during a measurement period so that each phase identified in the measured phase values MBV is stored in flop circuit 414.

For example, flop circuit 414 can have four flops that correspond with the four-bit measured phase values, where a first flop receives phase P0 data (the X in X-0-0-0), the second flop receives phase P1 data (the X in 0-X-0-0), the third flop receives phase P2 data (the X in 0-0-X-0), and the fourth flop receives phase P3 data (the X in 0-0-0-X).

Thus, at the end of a measurement period, if only phase P0 has been detected, then the measured phase value MBV has always been equal to 1-0-0-0. As a result, only the first flop holds a logic one with the remaining flops holding a logic zero. Thus, when the first flop is the only flop to hold a logic one, then only the first phase P0 was detected.

On the other hand, if phases P0 and P1 have been detected, then measured phase value MBV has been either 1-0-0-0 or 0-1-0-0. As a result, both the first and second flops hold a logic one, while the remaining flops hold a logic low. Thus, when the first and second flops both hold a logic high, both the first and second phases P0 and P1 were detected.

At the end of a measurement period, a result circuit 416 generates a two-bit validated phase value VBV that represents the measured phase values MBV that were recorded during the measurement period. The following TABLE and subsequent discussion illustrates the four-bit measured phase values MBV that can be recorded during a measurement period, and the corresponding validated phase values VBV that are output in response.

TABLE

| MBV | | | | VBV | | |
|---|---|---|---|---|---|---|
| Phase 0 | Phase 1 | Phase 2 | Phase 3 | Phase Value | EN | Note |
| 0 | 0 | 0 | 0 | 0 | 0 | 1 |
| 0 | 0 | 0 | 1 | 3 | 1 | 2 |
| 0 | 0 | 1 | 0 | 2 | 1 | 3 |
| 0 | 0 | 1 | 1 | 3 | 1 | 4 |
| 0 | 1 | 0 | 0 | 1 | 1 | 5 |
| 0 | 1 | 0 | 1 | 1 | 0 | 6 |
| 0 | 1 | 1 | 0 | 1 | 1 | 7 |
| 0 | 1 | 1 | 1 | 1 | 0 | 8 |
| 1 | 0 | 0 | 0 | 0 | 1 | 9 |
| 1 | 0 | 0 | 1 | 3 | 1 | 10 |
| 1 | 0 | 1 | 0 | 2 | 0 | 11 |
| 1 | 0 | 1 | 1 | 3 | 0 | 12 |
| 1 | 1 | 0 | 0 | 0 | 1 | 13 |
| 1 | 1 | 0 | 1 | 1 | 0 | 14 |
| 1 | 1 | 1 | 0 | 2 | 0 | 15 |
| 1 | 1 | 1 | 1 | 3 | 0 | 16 |

Note 1:
Phase unknown. No measurement made yet. Initial state before start of measurement.
Note 2:
Phase okay, only phase P3 measured.
Note 3:
Phase questionable. Only phase P2 measured, but could possibly be between phases P1 and P2.
Note 4:
Phase okay. Measurement has gone between phases P2 and P3.
Note 5:
Phase questionable. Only phase P1 measured, but could possibly be between phases P1 and P2.
Note 6:
Phase bad. Erroneous measurement.
Note 7:
Phase bad. Measurement has gone between phases P1 and P2, which can cause variations in the timing of the start of frame pulses.
Note 8:
Phase bad. Erroneous measurement.
Note 9:
Phase okay. Only phase P0 measured.
Note 10:
Phase okay. Phase has gone between phases P3 and P0.
Note 11:
Phase bad. Erroneous measurement.
Note 12:
Phase bad. Erroneous measurement.
Note 13:
Phase okay. Measurement has gone between phases P0 and P1.
Note 14: Phase bad. Erroneous measurement.
Note 15: Phase bad. Erroneous measurement.
Note 16: Phase bad. Erroneous measurement.

As shown in FIGS. 5E-5G, the rising edge of the first clock signal CLK1A corresponds with the first phase P0 of pulse RFP1, and the fourth phase P3 of pulse RFP2. In this case, phase position detect circuit 212 outputs a series of measured phase values MBV that identify only phase P0 when the burst CDR reset pulse RST always satisfies the threshold set up and hold times of synchronizer 402, and only phase P3 when the burst CDR reset pulse RST always misses the threshold set up and hold times of synchronizer 402.

In addition, the series of measured phase values MBV can also identify both phase P0 and phase P3 when the burst CDR reset pulses RST are so close to the threshold set up and hold times that the times are sometimes just satisfied and sometimes just missed. The occurrence of both phases P0 and P3 corresponds with note 10 of the TABLE, while the occurrence of only phase P0 corresponds with note 9 of the TABLE, and the occurrence of only phase P3 corresponds with note 2 of the TABLE.

When processor 114 subsequently reads the validated phase value VBV from DAPA circuit 118, processor 114 need not alter the value in the burst CDR generation register 112A when the validated phase value VBV indicates that both phases P0 and P3 are present, or only phase P0 or P3 is present, because both regenerated frame pulses RFP1 and RFP2 have a logic high when the falling edge of the first clock signal CLK1A occurs.

As shown in FIGS. 5E, 5F, and 5I, the rising edge of clock signal CLK1B corresponds with the second phase P1 of pulse RFP1, and the first phase P0 of pulse RFP2. In this case, phase position detect circuit 212 outputs a series of measured phase values MBV that identify only phase P1 when the burst CDR reset pulse RST always satisfies the threshold set up and hold times of synchronizer 402, and only phase P0 when the burst CDR reset pulse RST always misses the threshold set up and hold times of synchronizer 402.

In addition, the series of measured phase values MBV can also identify both phase P0 and phase P1 when the burst CDR reset pulses RST are so close to the threshold set up and hold times that the times are sometimes just satisfied and sometimes just missed. The occurrence of both phases P0 and P1 corresponds with note 13 of the TABLE, while the occurrence of only phase P0 corresponds with note 9 of the TABLE.

When processor 114 subsequently reads the validated phase value VBV from DAPA circuit 118, processor 114 need not alter the value in the CDR burst generation register 112A when the validated phase value VBV indicates that both phases P0 and P1 are present, or only phase P0 is present, because both regenerated frame pulses RFP1 and RFP2 have a logic high when the falling edge of the first clock signal CLK1B occurs.

As shown in FIGS. 5E, 5F, and 5K, the rising edge of clock signal CLK1C corresponds with the fourth phase P3 of pulse RFP1, and the third phase P2 of pulse RFP2. In this case, phase position detect circuit 212 outputs a series of measured phase values MBV that identify only phase P3 when the burst CDR reset pulse RST always satisfies the threshold set up and hold times of synchronizer 402, and only phase P2 when the burst CDR reset pulse RST always misses the threshold set up and hold times of synchronizer 402.

In addition, the series of measured phase values MBV can also identify both phase P2 and phase P3 when the burst CDR reset pulses RST are so close to the threshold set up and hold times that the times are sometimes just satisfied and sometimes just missed. The occurrence of both phases P2 and P3 corresponds with note 4 of the TABLE, while the occurrence of only phase P3 corresponds with note 2 of the TABLE.

When processor 114 subsequently reads the validated phase value VBV from DAPA circuit 118, processor 114 need not alter the value in the CDR burst generation register 112A when the validated phase value VBV indicates that both phases P2 and P3 are present, or only phase P3 is present, because both regenerated frame pulses RFP1 and RFP2 have a logic high when the falling edge of the first clock signal CLK1C occurs.

However, as shown in FIGS. 5E, 5F, and 5M, the rising edge of clock signal CLK1D corresponds with the third phase P2 of pulse RFP1, and the second phase P1 of pulse RFP2. As noted above, the difference between phases P1 and P2 causes the start of frame pulse SOF to vary by one first clock signal CLK1 as shown in FIGS. 5N and 5P.

Thus, in this case, phase position detect circuit 212 outputs a series of measured phase values MBV that identify only phase P2 when the burst CDR reset pulse RST always satisfies the threshold set up and hold times of synchronizer 402, and only phase P1 when the burst CDR reset pulse RST always misses the threshold set up and hold times of synchronizer 402.

In addition, the series of measured phase values MBV can also identify both phase P1 and phase P2 when the burst CDR reset pulses RST are so close to the threshold set up and hold times that the times are sometimes just satisfied and sometimes just missed. The occurrence of both phases P1 and P2 corresponds with note 7 of the TABLE.

In addition, the occurrence of only phase P1 corresponds with note 5, while the occurrence of only phase P2 corresponds with note 3 of the TABLE. The occurrence of only phase P1 or only phase P2 is questionable as indicated in the notes because the amount of margin that is available to meet the set up and hold timing requirements of synchronizer 402 is unknown.

Thus, when processor 114 subsequently reads the validated phase value VBV from DAPA circuit 118, processor 114 reads a register value from memory 116 when the validated phase value VBV indicates that both phases P1 and P2 are present, and then writes the register value into burst CDR generation register 112A. This alters the timing the burst CDR reset pulse RST which, in turn, changes the detected phases.

In addition, when the validated phase value VBV indicates that phase P1 or phase P2 is present, processor 114 can optionally read a register value from memory 116, and then write the register value into burst CDR generation register 112A to alter the timing of the burst CDR reset pulse RST to ensure that sufficient margin is available.

As noted above, at the end of the measurement period, result circuit 416 outputs a validated phase value VBV that identifies the phase relationships that were detected. For example, flop circuit 414 can identify only phase P3 when flop circuit 414 detects measured phase values MBV that each indicate that phase P3 was detected. At the end of the measurement period, result circuit 416 asserts the enable signal EN, and outputs a validated phase value VBV that indicates that phase P3 is the only detected phase value.

The validated phase value VBV and the enable signal EN can be output from result circuit 416 to an output register 420 of DAPA circuit 118. The validated phase value VBV and the enable signal EN can be read by connecting communication path BUS to output register 420 on DAPA circuit 118 (as shown by the dashed lines connected to communication path BUS).

In an alternate embodiment, MAC 112 can include a validated value register 112B. In the alternate embodiment, MAC 112 receives the validated phase value VBV and the enable signal EN from output register 420 and stores the information in validated value register 112B. Processor 114 then reads the information from validated value register 112B via communication path BUS (as shown by the dashed lines connected to register 112B).

In the present example, sampling logic circuit 210, phase position detect circuit 212, and measure validation and integration circuit 214 can be implemented using, for example, a programmable logic device (PLD), such as the ispXPLD (Part No.: LC5256MV-5F256I) manufactured by Lattice Semiconductor Corporation.

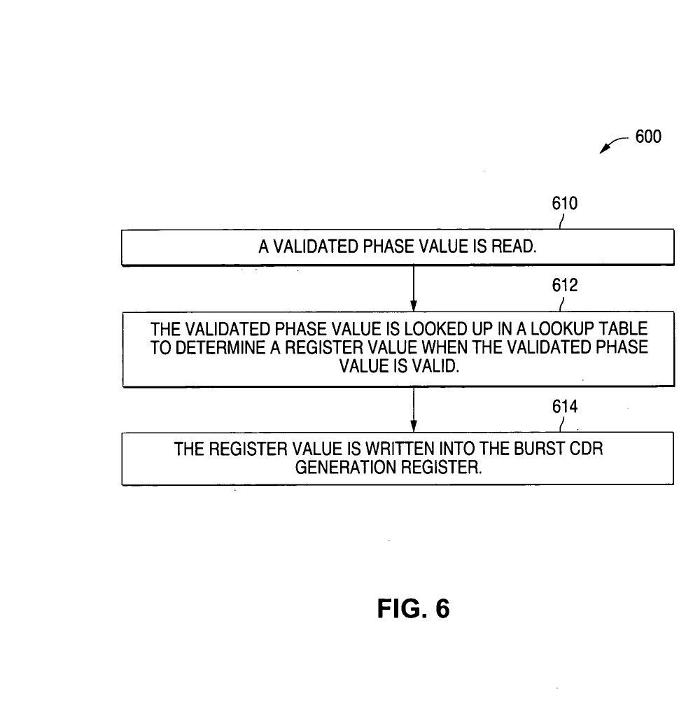

FIG. 6 shows a flow chart that illustrates an example of a method 600 of determining a value for a burst CDR generation register, such as burst CDR generation register 112A, in accordance with the present invention. As shown in FIG. 6, at 610, a validated phase value, which indicates which phase of the regenerated frame pulse RFP is aligned with the rising edge of the sampled signal SLK, is read. For example, processor 114 can read a validated phase value VBV from validated value register 112B or output register 420.

At 612, the validated phase value is looked up in a lookup table to determine a register value, when the validated phase value is valid (enable signal EN is valid). Optionally, at 612, the validated phase value can be looked up in the lookup table to determine a register value only if needed. The validated phase value needs to be looked up when the validated phase value indicates that phases P1 and P2 are present, and can be optionally looked up when only phase P1 or phase P2 is present. In this case, the register value is only written into burst CDR generation register 112A when needed. This option eliminates the need to continually write to burst CDR generation register 112A.

At 614, the register value is written into the burst CDR generation register. For example, processor 114 can write the register value into burst CDR generation register 112A via communication path BUS. The register value, in turn, can change the edge of the burst CDR reset pulse RST by one bit time (one second-clock period) which, in turn, changes the edge of the burst CDR reset pulse RST by one bit time (one second-clock period).

In the present example, the seed value originally placed in burst CDR generation register 112A, which can be an empirically determined value, takes into account all of the delays from MAC 112 through DAPA circuit 118 to TM 110 to place the rising edge of the start of frame signal SOF at the correct point as required by TM 110. When the register value is placed in burst CDR generation register 112A, the register value advances or retards the position of the start of frame pulse SOF (via the burst CDR reset pulse RST) by one bit time (one second-clock period).

Thus, the present invention allows a TM and a MAC, which have incompatible interfaces, to be connected together and satisfy the timing requirements of the TM. In addition, processor 114 and DAPA circuit 118 continually monitor the system to detect any changes in the measured phase value MBV that may occur over time.

It should be understood that the above descriptions are examples of the present invention, and that various alternatives of the invention described herein may be employed in practicing the invention. Thus, it is intended that the following claims define the scope of the invention and that structures and methods within the scope of these claims and their equivalents be covered thereby.

What is claimed is:

1. An interface circuit comprising:
a sampling circuit to generate and output:
a sampled clock signal in response to a first clock signal and a second clock signal;
a plurality of intermediate frame pulses in response to a plurality of reset pulses and the second clock signal, each intermediate frame pulse having a width, the width having an integer number of phases defined by a corresponding number of second clock periods, the reset pulses and the second clock signal having an unknown phase relationship; and
a plurality of start of frame pulses in response to the intermediate frame pulses and the first clock signal.

2. The interface circuit of claim 1, further comprising a phase position detect circuit connected to the sampling circuit to determine a plurality of phase values over a measurement period, each phase value representing a phase of an intermediate frame pulse that corresponds with an active edge of the sampled clock signal.

3. The interface circuit of claim 2, wherein the phase position detect circuit comprises a logic measuring circuit to determine which phase of the intermediate frame pulse coincides with the active edge of the sampled clock signal.

4. The interface circuit of claim 3, wherein the logic measuring circuit detects a first logic state of the sampled clock signal that occurs with a rising edge of the intermediate frame pulse, and a second logic state of the sampled clock signal that occurs one second-clock period after the rising edge of the intermediate frame pulse.

5. The interface circuit of claim 4, wherein the logic measuring circuit determines a measured phase in response to the first and second logic states, the first and second logic states uniquely defining which phase of the intermediate frame pulse coincides with the active edge of the sampled clock signal.

6. The interface circuit of claim 5, wherein the phase position detect circuit further comprises an output circuit connected to the logic measuring circuit to generate a plurality of measured phases in response to the plurality of phase values.

7. The interface circuit of claim 2, wherein the phase position detect circuit outputs a plurality of measured phases over the measurement period in response to the phase values.

8. The interface circuit of claim 7, further comprising a measure validation circuit connected to the phase position detect circuit to receive and record the plurality of measured phases that were detected during the measurement period.

9. The interface circuit of claim 8, wherein the measure validation circuit comprises a storage circuit that is connected to receive the plurality of measured phases, each phase identified in the plurality of measured phases being stored in the storage circuit.

10. The interface circuit of claim 9, wherein the measure validation circuit further comprises a result circuit to output a validated phase value at the end of the measurement period that identifies each phase that was detected and stored.

11. A method of operating an interface circuit, comprising:
generating a plurality of timing signals, the timing signals including a sampled clock signal, a plurality of intermediate frame pulses, and a plurality of start of frame pulses; and
when a measurement period begins, detecting and outputting a plurality of phase values, each phase value representing a phase of an intermediate frame pulse that corresponds with an active edge of the sampled clock signal.

12. The method of claim 11, further comprising recording the plurality of phase values and, when the measurement period is over, generating and outputting a validated phase value that represents the phase values that were recorded during the measurement period.

13. The method of claim 12, wherein generating a plurality of timing signals includes:
forming the intermediate frame pulse in response to an edge of the second clock signal and an edge of a reset pulse, the intermediate frame pulse having a width defined by a plurality of phases that correspond to a plurality of periods of the second clock signal; and
forming a start of frame pulse in response to the intermediate frame pulse and the first clock signal.

14. The method of claim 11, further comprising generating a plurality of measured phases in response to the plurality of phase values.

15. The method of claim 11, wherein detecting a plurality of phase values includes determining a first logic state of the sampled clock signal that occurs with a rising edge of the intermediate frame pulse.

16. The method of claim 15, wherein detecting the plurality of phase values includes determining a second logic state of the sampled clock signal that occurs one second-clock period after the rising edge of the intermediate frame pulse.

17. The method of claim 16, wherein detecting the plurality of phase values includes determining a measured phase in response to the first and second logic states, the first and second logic states uniquely defining which phase of the intermediate frame pulse coincides with the active edge of the sampled clock signal.

18. The method of claim 17, wherein detecting the plurality of phase values includes generating a plurality of measured phases in response to the plurality of phase values.

19. A method of determining a value for a burst CDR generation register, comprising:
reading a first value, the first value identifying a phase relationship of a first signal to a second signal;
looking up the first value in a look up table to determine a register value when the first value is valid; and
writing the register value into the burst CDR generation register, the register value held by the burst CDR generation register defining a timing of the first signal.

20. The method of claim 19, and further comprising:
determining if the first value is a need-to-change value; and
looking up the first value in the look up table only when the first value is a need-to-change value.
